(19) United States
(12) Patent Application Publication
(10) Pub. No.: US 2011/0010181 A1
(43) Pub. Date: Jan. 13, 2011

(54) Access, steps and services for trade systems, process and interface

(76) Inventor: Rajen Iyer, (US)

Correspondence Address: Rajen Iyer, 34272 Lennox Ct., Fremont, CA, 94555, US

(21) Appl. No.: 12/459,958

(22) Filed: Jul. 11, 2009

(51) Int. Cl. G06Q 30/00

(52) U.S. Cl. 705/1.1; 705/331

(57) ABSTRACT

A trade system is disclosed, registering a product, triggering an automatic selection of a product classification or product content attributes from a transactional system; registering a business partner, triggering an automatic selection of business partner attributes from the transactional system; halting further processing of the transaction if the transaction is denied and automatically forwarding transaction information to a transaction review process, or allowing the transaction process to proceed if the transaction allowed, automatically creating a business transaction and generating transaction specific documents.

### TECHNICAL FIELD

The present invention relates generally to the fields of commercial trade management systems and, in particular, to management systems for use with securitized trades, including the shipping and handling of goods, such as commercial goods in a trade zone, in order to ensure compliance with customs procedures.

### BACKGROUND

Trade preferences are measures that grant preferential customs treatment or limitations for goods imported or exported between particular countries or geographical areas. Trade preferences, and the related rules and procedures, or a benefit to both the importing and exporting economies.

Historically, customs authorities in dealing with trade transactions have used paper-based procedures to manage and record import and export transactions for commercial goods. Recently many customs authorities have progressed to electronic or computerized organization and tracking of the customs and trade processes.

In trade systems, although communication and systems are supported by computerized processes, many procedures, logistic processes, and electronic or computerized systems are still separated and often handled by different organizations or different systems. In fact, some processes may interfere with other corresponding logistical processes required for the inbound or outbound movement of goods.

Compliance with customs procedures is a requirement for trade systems, however it is desirable and there is still room for improvement to integrate current individual systems or procedures. One field that potentially permits a high degree of automation is trade preference process. Trade regulation validations are performed for export with outbound transactions and import for inbound transactions.

Generally, existing Trade Systems are tightly interfaced to their own backend system. They tie very closely with their own Enterprise Resource Planning application and limit its application to each individual process and also limit access to other partners such as internal employees or they limit access to outside partners. The limitations provided by individual vendors confine the use and application to certain business processes within an Enterprise.

An improvement in integrating separate or individual systems, and potentially systems and services provided by multiple or different vendors, is needed.

### SUMMARY

An exemplary embodiment of the present invention provides a method of generating trade system transaction documentation, including the steps of registering a product and triggering an automatic selection of a product classification or product content attributes from a transactional system and also registering a business partner, triggering an automatic selection of business partner attributes from the transactional system. These steps may be applied in any order.

The product classification or product content attributes are automatically compared with the trade regulation attributes. A transaction flag to allow or deny a transaction is then set. If the transaction flag is set to deny a transaction, then a normal process flow of generating the trade system transaction documentation is halted and any transaction information is automatically forwarded to a transaction review process. If the transaction flag is set to allow a transaction, the transaction process is allowed to proceed a business transaction is automatically created and transaction specific documents are generated.

The present invention has the advantage of providing a single interface to a plurality of trade management tools

### BRIEF DESCRIPTION OF THE DRAWINGS

FIG. 1A is a flow chart of an exemplary high level functions and features of a Trade System Application

FIG. 1B is a block diagram of an exemplary computer, electronic, or data processing system which may be used to execute an embodiment of the invention.

FIG. 1C is an exemplary computer system or architecture that the invention may be run on.

FIG. 2 is a flow chart of an exemplary high level functions and features of a Trade Systems Process Steps

FIG. 3 is a flow chart of an exemplary Trade Systems Backend Applications

FIG. 4 is a flow chart of an exemplary Trade Systems Trade Product Access process, and a flow chart of an exemplary Trade Systems Process Step and Services process

FIG. 5 is a flow chart of an exemplary Trade Systems Trade Business Partner Access process, and a flow chart of an exemplary Trade Systems Process Step and Services process

FIG. 6 is a flow chart of an exemplary Trade Systems Trade Transactional Access process, and a flow chart of an exemplary Trade Systems Process Steps and Services process

### DETAILED DESCRIPTION

Presented in this invention is a computer system, computer or automated process or a method that decouples the trade process and provides the flexibility to expand a computerized trade process solution beyond a single or specific ERP or other trade process application, for example operating within an enterprise computer system.

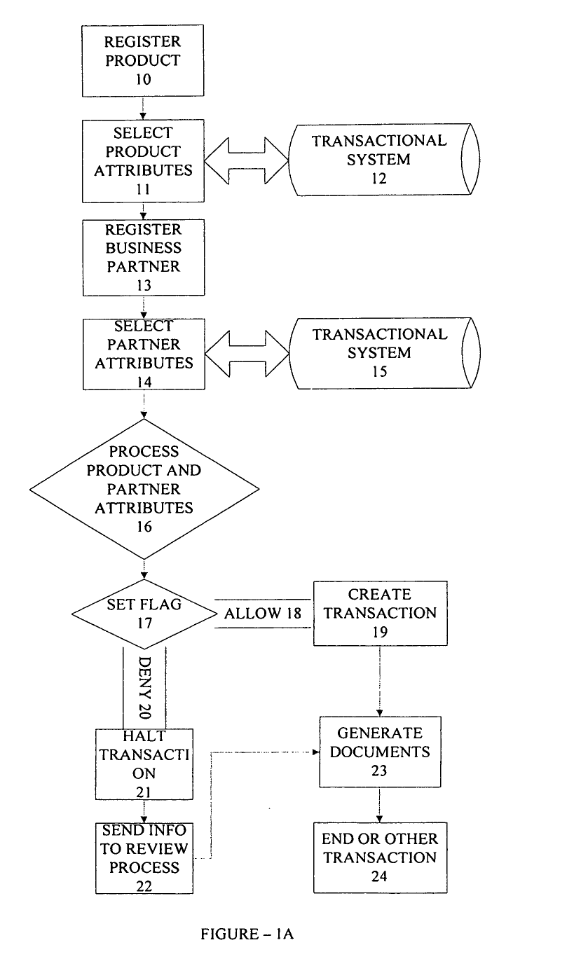

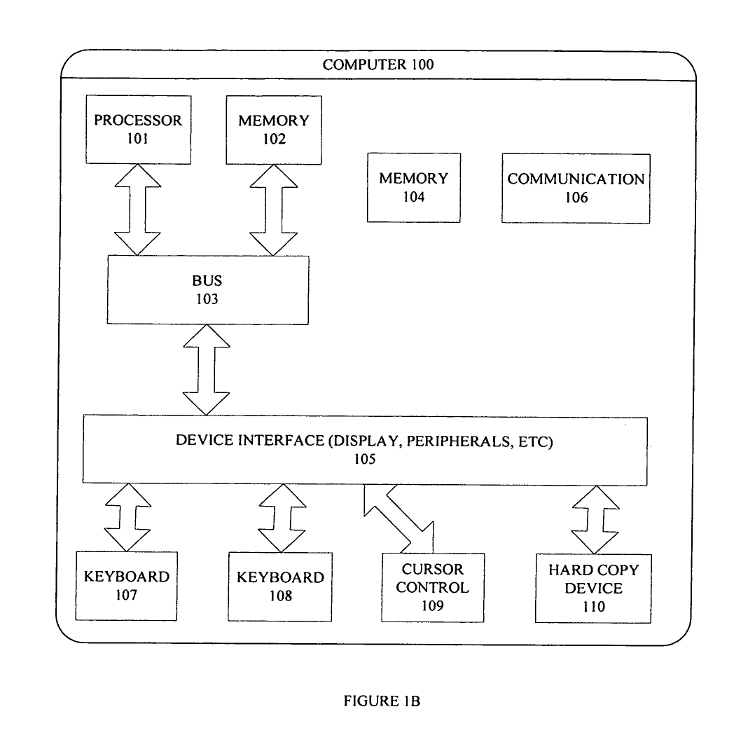

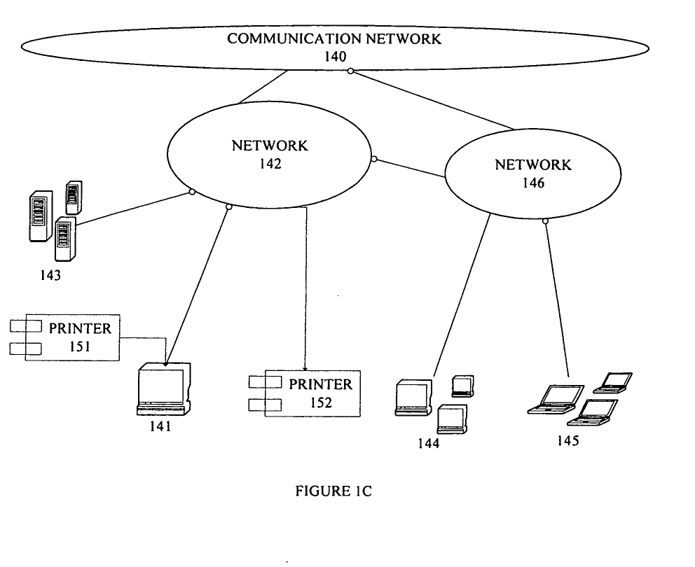

Referring to FIG. 1A, an exemplary embodiment of the invention is shown. A computer, electronic, or data processing system that processes or generates a trade system transaction, includes the first step of registering a product 10. Once a product is registered, an automatic selection of a product classification or at least one product content attribute 11 from a transactional system 12 is triggered. In one exemplary embodiment, the transactional system used to register the product is the same system that is used to automatically select a product classification. In another exemplary embodiment, the transactional system used to register the product is a different system than the transactional system used to automatically select a product classification.

Next, a customer or business partner is registered 13. The registration of the customer or business partner triggers an automatic selection of at least one business partner attribute 14 from a transactional system 15. In one exemplary embodiment, the transactional system used to automatically select at least one business partner attribute is the same system used to register the customer or business partner. In another exemplary embodiment, the transactional system used to automatically select at least one business partner attribute is a different system than the transactional system used to register the customer or business partner.

Next, the product classification or product content attributes are automatically compared 16 with trade regulations and the business partner attributes 14 with the restrictive list and a transaction flag is set 17. A transaction system or a transaction process indicator is set 15 to indicate whether the specific transaction should be allowed 18 or denied 19. If the transaction should be denied 19, further processing of the transaction is halted 21. The transaction information is then automatically forwarded to a transaction review process 22. In one exemplary embodiment, when the transaction information is automatically forwarded to a transaction review process, a transaction review form is generated 23 which includes the customer or business partner name, the product and product classification, and a description or indicator for denying the transaction.

If the transaction should be allowed 18, the transaction process proceeds and a business transaction is automatically created 20, optionally generating transaction specific documents 23. In one exemplary embodiment, the transaction specific documents are printed in any form or format acceptable by the United States Customs Service. In another exemplary embodiment, the transaction specific declarations or online submissions 24 are generated in an electronic or computer readable form or format that is acceptable by the different countries' Customs Service.

Referring to FIG. 1B, a block diagram of a computer, electronic, or data processing system 100 may be used to execute an embodiment of the invention. Computer system 100 is comprised of a processor 101 that may represent single or multiple processors, such as the Pentium® processor (Intel Corporation®, Santa Clara, Calif. 95052) or other processors. Processor 101 is coupled with bus 103 to communicate information to other blocks or devices. Computer system 100 further comprises a memory 102 coupled to bus 103 for storing information and instructions to be executed by processor 101. Memory 102 also may be used for storing temporary variables or other intermediate information during execution of instructions by processor 101. Memory 102 may be a semiconductor dynamic random access memory (DRAM) and/or a static rain (SRAM) and/or a Read only Memory (ROM), etc. Bus 103 further couples the processor 101 to device interface 105.

Device interface 105, may include a display controller, and is coupled to the following devices 1) a mass memory device 104, which may be a hard drive, an optical drive such as a CD-ROM, etc., that retains stored data even when power is not applied to the mass memory device; 2) a Communication Device 106; 3) a display device 107, which may be a cathode ray tube (CRT) display, a liquid crystal display (LCD), or a plasma display, etc. for displaying information to a computer user; 4) a keyboard device 108 or other alphanumeric input device; 5) a cursor control device 109 such as a mouse, trackball, or other type of device for controlling cursor movement on display device 107; and 6) a hard copy device 110.

In addition, the invention may be stored on the mass memory device 104 with an operating system and other programs. For example, the computer system 100 may be a computer running a Windows operating system, a Macintosh operating system, a Unix operating system, etc. In one embodiment, the software used to facilitate the invention can be embodied onto a machine-readable medium. A machine-readable medium includes a mechanism that provides (e.g., stores and/or transmits) information in a form readable by a machine (e.g., a computer). Slower mediums may also be cached to improve performance. The communication interface in computer 100 may be coupled to a variety of other external devices including networks, remote computers, phones, personal digital assistants, printers, etc.

It will be appreciated that the description of computer system 100 represents only one example of a system, which may have different configurations, architectures, and other circuitry that may be employed with the embodiments of the present invention. In addition, a computer readable medium may include but is not limited to a magnetic medium, a semiconductor medium, a light readable medium, or any other device or medium capable of storing computer operable instructions. While some specific embodiments of the invention have been shown, the invention is not to be limited to these embodiments. For example, most functions performed by electronic hardware components may be duplicated by software emulation. Thus, a software program written to accomplish those same functions may emulate the functionality of the hardware components in input-output circuitry. The communication interface in computer 100 may be coupled to a variety of other external devices including networks, remote computers, phones, personal digital assistants, printers, etc.

Referring to FIG. 1 C, a computer may be coupled to a network environment in which the present invention may operate. For example, the invention may access and operate on program instructions residing on a server 143 connected to a network. In this exemplary network diagram, server system 143 is coupled to a wide-area network 142. Wide-area network 142, also coupled to computer 141 and indirectly to desk tops 144 and laptops 145, includes the Internet or other networks well known to those of ordinary skill in the art, who will recognize other networks, architectures, and topologies as being equivalent in operation. Server 143 may communicate through network 142 to a plurality of client computer systems 141, 144, and 145. For example, client 141 may be connected through network 142 to server 143, while clients 144 and 145 may be connected through network 142 to server 143 via local network 146. An embodiment may access a program file from server 143, operate on the file, and then send the result to computer system 144 for execution. In addition, computer 141 may access programs, files, or data locally or from other systems such as a server 143 or other computer systems 144, 145. In one embodiment, after the computer 141 has processed the programs, files, or data, results or forms may be sent to a local printer 151 or set to a remote printer 152, for example.

In another embodiment, after the computer 141 has processed the programs, files, or data, electronic results or forms are generated. Electronic results or files are stored in a variety of formats which include but are not limited to PDF formats, EDI (electronic data interchange) formats, Web interface formats such as HTML, ANSI (American Nation Standards Institute) standard formats, for example, the X12 standards for tracking goods (Shipment Notice 856), ordering (purchase order 850) and invoicing (Invoice 810), middleware, for example, transactional, message oriented, and others. The electronic results or files may be stored on a computer 141 for further processing or local printing, or the electronic results or files may be transferred to a server 143 using a file transfer protocol (FTP), other utility, or program such as an electronic mail (e-mail) application.

When companies use an ERP system to perform their supply chain transactions, they will have to perform export or import check based on the goods being sent out or received into the country. These trade checks can be performed using one of Trade Systems application by interfacing with the ERP System. Any transaction within the ERP for the companies has product and business partner, from trade point of view these products are identified for export or import classification, business partner for screening with denied party list and check for license for permission to export or import.

When customer requests for a part or service, the company will acknowledge this with an order, which is represented in the backend system Sales Order in the ERP system. If this part has to be shipped to a different country and crosses border, export regulation of the departing country will apply. This supply chain process will check for trade compliance within a Trade services system. Similarly, if the company plans to purchase goods from a vendor, located in different country, it will have to comply to import regulations.

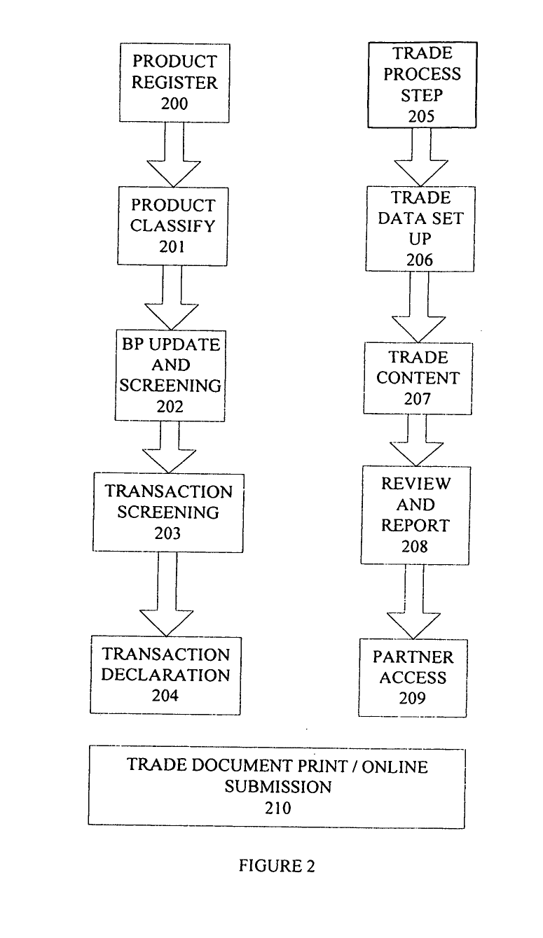

Referring to FIG. 2, another exemplary embodiment for a standalone Trade Systems and Application are shown. The registration of a Product 200 is based on the product created in a backend system and subsequently, a Classification of the Product 201 is automatically triggered.

In a typical ERP system, for example, from vendors such as SAP or Oracle, the material is registered within the ERP system under the material or product master tables, database or views. Information related to the material is captured for different functions within the organization, for example, purchasing, planning, sales, etc. There is information that is important for the Trade processing, that needs to be captured within the ERP system and transferred to the Trade system for validation and information update, for example, the material or product number coming from the ERP system, its description, weight, units of measure. As the ERP saves and confirms the information is complete, it can trigger these information to the Trade System and any following changes need to be transmitted to the Trade system.

Similar Business Partner Updates or Screening processes 202 are triggered following the creation of business partner data in the backend system. Similar to the product or material master creation, Business Partner creation triggers a data transfer to the Trade system. Business partners within the ERP system may be customers, vendors or employees. These business partners perform certain functions within the company and from the Trade point of a trade partner. When a Business Partner is registered within an ERP system as master data, different types of data elements important to different functions within the company are created and the information specific to Trade, for example the name and address, are transferred to the Trade system in registering the information and screening them for any potential match on one of the denied party lists. Customers' information are usually used within the sales transaction for outbound Trade and vendors' information-ware usually used for the transaction for an inbound Trade process. Prior registering and screening enables the approval and processing of transactions.

A Transaction Simulation Screening process 203 is invoked based on the particular type of transaction sales/purchase that has been created in the backend system. Within an ERP system for example, from vendors such as SAP or Oracle, sales, purchase or inventory movements are registered within the system as transactions and system records. Electronic documents may be created for tracking and audit purposes. There are data elements relating to the information pertaining to the transactions that are recorded. For example, for a sales transaction, the information of the buyer, shipping address, product details, the delivery schedule, shipment priority, mode of payment, etc are captured. Following the information capture in the ERP system, the transfer of data from the ERP system to other sub-system or processes is triggered, for example, the sales creation might trigger the materials requirement planning, shipping, etc and information related to sales transactions for trade screening purpose are then transferred to Trade system.

Following the screening of the document, if the combination of the Business Partner and the Product Classification are cleared, the Trade System Process is then prepared for a Transactional Declaration 204.

The information important to Trade system are the business partner, whom you are shipping the product to, the country it is being shipped out of and to and the product that is being shipped.

A Trade Process set up 205, which includes the entry of specific data or information, may be required to perform steps 200 through 204 using particular Trade Systems and Services for a Trade Business System. A Trade Data set up process 206 ensures all the Trade requirements are set up in the system. Trade content 207 enables the content that is required based on Trade regulations for example Export and Import classifications, Denied party list, Duty Rates, etc. Trade process involves Review and Report 208 for Internal Review, Execution and Reporting to internal and external partners. To help process the shipment across border for export and import, there are partners like, Freight Forwarder, Carrier, etc involved and the Trade System sends data or grants access to these external partners, through Partner Access 209 for execute and updates to the document.

Details, data or information are needed to trade or transfer goods into or out of a country. A variety of data elements are pulled or copied from the ERP and Trade system to generate transaction documents. Exemplary details, data, or information used in the Trade process may include, but is not limited to: product (registration) data, transactional data, product classification data, import or export control attribute information associated with the product, as well as customer or business partner information.

Transaction documents are printed or generated in an electronic or computer readable form used by entities or agencies, for example, such as the US Customs. Referring to FIG. 2, the Trade Document Print/Online Submission 210 step, may be implemented, for example, using US Customs uses form 7525-V as the shipper's export declarations to declare the products being shipped out. In another exemplary embodiment, Companies currently obligated to report products shipped out with values over and above $2500 may use a schedule B classification number, quantity and other details.

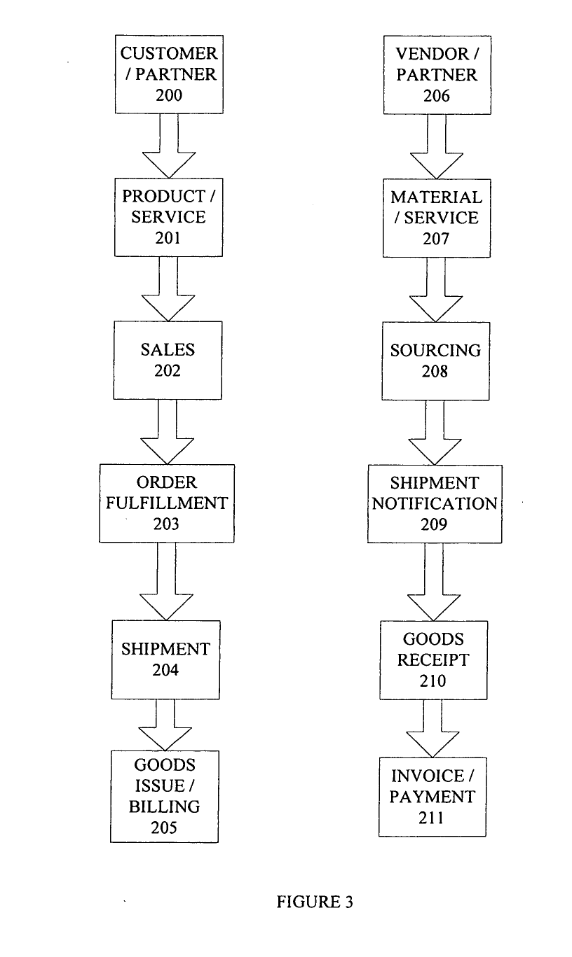

Referring to FIG. 3, in one embodiment a backend system and Application is an ERP (Enterprise Resource Planning) Application, Customer Relationship Management, Supply Chain Management System, or a Logistics System, where the source of the business data and transaction information originates. In another example of an ERP system, the Export Process starts with a first step off identifying or recording of Customer/Partner 300 information and Product/Service 301 information in a Transaction System. If a contractual agreement with a customer exists, the contract with a customer is acknowledged with eight related Sales 302 order and is pushed to an Order Fulfillment 303 process to complete the delivery of a product or service. A Shipment 304 process begins by preparing the product or service that is to be delivered to the customer's requested address. Once shipped, the product or services (Goods) are issued and in a subsequent step, the customer is billed 305. With the inbound transaction, the process starts with the registry of the vendor or the partner 306 record within the ERP system and material/services 307, you procure from them. The organization goes through sourcing 308 to procure the goods/service from the vendor or partner. When the goods are shipped, the shipment notification 309 is send. Following the goods receipt the vendor invoice is settled with the payment 311.

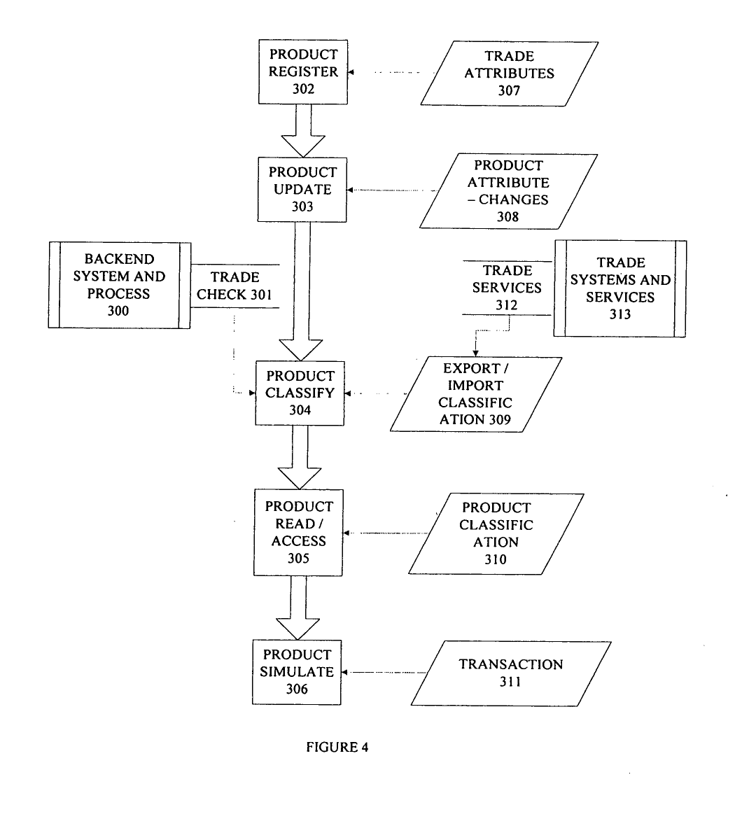

Referring to FIG. 4, the Trade Product Access, Process Steps and Services system, the Backend System and Process 400 represents the exemplary ERP system presented in FIG. 3. Trade Check 401 is a signal from a backend system. The information captured in a particular sequence or a particular function includes the first step in the process for Trade Product Services (FIG. 4). A Product Register 402 step or function is performed when a part number is created in a product registration system. A Trade Check 401 process is triggered when product information is initially created in a Backend System and Processes 400 process. The Trade Check 401 process sends me product information to a Trade System and Services 413 system with least one, or a collection of Trade Attributes 407. Any changes to the product information are captured in the service update, specific to any Product Attribute Changes 408 or Product Update 403 functions. Once the products information or attributes are in the Trade System, a Product Classify 404 process defines the service for assigning the Export and Import Classifications 409. Once the classification information is updated, the service check for Product Read/Access 405 is optionally invoked to read product information from the Product Classification 410 system. Trade checks are performed or simulated using information from a Transaction 411 system and a Product Simulate 406 service check.

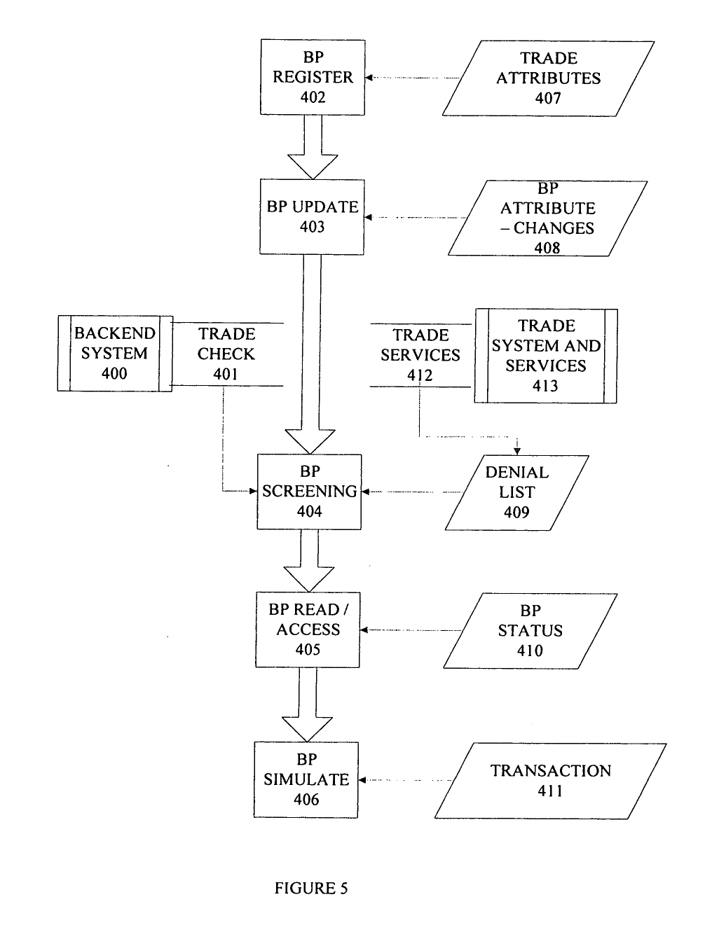

Referring to FIG. 5, an exemplary Trade Business Partner Access, Process Steps and Services process is shown. The Backend System and Process 500 represents the ERP system disclosed in FIG. 3. A Trade Check 501 is a signal, process, or data transfer from the backend system that is captured to process the information to perform a portion of a Trade function. The first step in the process for Trade Business Partner (BP Services, FIG. 5) is the BP Register 502, when the business partner is created in the system. Trade Check 501 is triggered when the business partner is initially created in the Backend System and Processes 500 and a Trade Check 501 is sent to the Trade System and Services 513 with the Trade Attributes 507. Any changes to the business partner is captured in the service update, specific to the BP Attribute Changes 508 or BP Update 503. Once the business partner information or data are in the Trade System, the BP Screening 504 defines the service for checking the business partner against the Denied List 509. Once the business partner information or data is updated in the trade system and screened, a service check for BP Read/Access 505 may be invoked to read the BP Read/Access 510. Trade checks are performed for simulated Transaction 511 with the BP Simulate 506 service check.

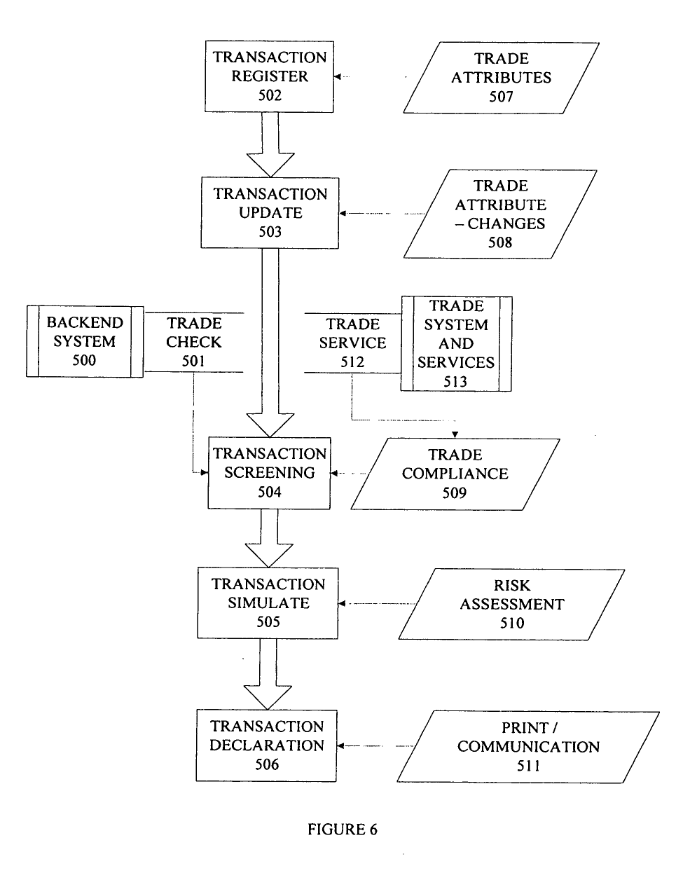

Referring to FIG. 6, a Trade Transactional Access, Process Steps and Services process is shown. A Backend System and Process 600 represents the ERP system explained in FIG. 3. Referring again to FIG. 6, a Trade Check 601 is performed which is a signal, process, or data transfer from a backend system that is captured to process the information. A particular sequence or a particular function is performed which may be specific to a chosen Trade system. A Trade Transactional Services or Transaction Register 602 is performed, when the transaction (sales order, purchase order, etc) is created in the system. A Trade Check 601 is triggered when the transaction is initially created in the Backend System and Processes 600 and a Trade Check 601 is sent to the Trade System and Services 613 system or module with the Trade Attributes 607. Any changes to the transaction are captured in the service update, specific to the Trade Attribute Changes 608 or Transaction Update 603. Once the transactions are in the Trade System, the Transactional Screening 604 defines the service for checking the transaction against the Trade Compliance 609. Transactions before being created in the backend system could be simulated with the Transactional Simulate 605 for Risk Assessment 610 assessment. Documentation and declarations services are performed using Transaction Declaration 606 for Print/Communication 611 of customs declarations.

Trade Processes are embedded within the Supply Chain Application or an Enterprise Resource Planning application might be interfaced with a standalone Trade application. Trade applications are built to perform Trade processes, for example, Product classification, Denied Party List Screening, License Determination, Documentation, etc. The methodologies identifies key touch points that are critical and essential to the Trade processes and application and build an interface, which would be standard to be used by any application or user for Trade specific checks and services. Trade Services are the different services checks that are invoked within the Trade Services and system. Transactions are recorded in the Trade Services system as Documents for transactions and Product and Business Partners for Master Data. The different Service Check or Access is performed using this invention.

The Trade System and Services are built to meet the trade requirements based on System Settings and Business rules, which reflects the trade rules and regulations-to represent the trade processes and the data/content that are registered within a database. The Partner Service involves Trade Services Access for display, simulate or update of different function with the Trade processes by the internal (different groups within the company) or external (customer, freight forwarder, broker or vendor). These partners could access the system for generation of Reports, or perform Update, Simulate a service check or perform a function/Execute, for example updating a Vendor declaration by vendor or updating a customs declaration by broker.

Backend Systems represents a feeder system, from where a request for service is originated. The request could be for Product create/change; Business Partner create/change; Product Attributes update for classification; Business Partner Screening for Service check; Transaction screening and Document Service for document generation for print or EDI communications to customs authorities. Different supply chain process within Trade processes are; Export or Import. The supply chain might request for report to facilitate the goods movement or run a simulation/s. The document to facilitate the outbound is the sales or shipments and the inbound for sourcing or procurement.

Optional interfaces are built or expanding the Trade Systems and Services beyond the chosen ERP or business application and access to partners, internal or external to the company. Exemplary internal Partners are the employees and others. Exemplary external Partners are vendors, customers, brokers, freight forwarders, and others.

In another exemplary embodiment, an SAP® GTS process is utilized, interfaced with an SAP® ERP application, such as SAP® R/3, ECC, or CRM. These functional modules provide a Business Application Process Interfaces (BAPI). For example, a GTS as a standalone application may be used, interfaced with an SAP ERP application system using a custom interface application based on the requirements for accessing the SAP® GTS application. Another embodiment may be used with an SAP® Global Trade Services application, and Oracle Application or a variety of other Trade Applications, with the objective of exposing the Trade Systems and Services beyond a standard pre-delivered interface for the internal and external access. SAP® GTS has different components with the latest release Compliance, Customs, Risk and Electronic Compliance Reporting. GTS supports an integrated process that checks compliance at each step of the customers' sales and purchasing operations. GTS can be one shared system for the complete backend system.

In a typical SAP® Global Trade Application, there are function modules (BAPI, BADI and ABAP/4 programs), which can used to build the interface with the right data mapping. The standard delivered interface with the SAP(& GTS is with the SAP®'s own ERPs (SAP R/3, ECC, etc) and this interface will enable to not only connect to SAP® ERP systems but also non-SAP systems. This application also provides an approach to build an interface with logistics or the transaction to other Trade Systems and Services. The application or interfaces' intent to help customers to expose these services to applications or to their business partner, who need to invoke the Trade services beyond SAP Graphic User Interface in case of SAP® GTS and application specific interfaces and come up with an open interface to Trade Services and Solutions.

In another exemplary embodiment, a web service interface application interfaces with the SAP® Global Trade Services application. The following list describes an exemplary high level approach on how to utilize some of the standard function modules (BAPI) or access available in SAP® GTS by wrapping or interfacing to a customs function module.
1. Create/Change Business Partner (SPL Screen Partners)
   Function module wrapped around /SAPSLL/API_{—}1006_SYNCH_MASS.
   Incoming data structures are mapped to API_{—}1006 structures
   Web-service interfaced to function module
2. Simulate SPL
   Function module wrapped around /SAPSLL/SPL_SCREENING_SCEN_S3
   Data for address screening are mapped
   Web-service interfaced to function module
3. Business Partner SPL Statuses
   Custom functional module
   Incoming Partner number and feeder system information access tables interfaced to /SAPSLL/PNTBP and /SAPSLL/ADRCON to get screening results
   Web-service interfaced to the custom function module
4. Create/Change Product Transfer
   Function module wrapped around /SAPSLL/API_{—}6850_SYNCH_MASS.
   Incoming data structures are mapped to API_{—}6850 structures
   Web-service interfaced to function module
5. Product classification status
   Custom function module
   Incoming Product Number feeder system information access tables interfaced to /SAPSLL/PR, /SAPSLL/PNTPR, /SAPSLL/PRCTS, /SAPSLL/PRGEN, /SAPSLL/PRTXT, /SAPSLL/CTSNUM and get the product classification details
   Web-service interfaced to the custom function module
6. Create/Change Customs Document
   Function module wrapped around /SAPSLL/API_{—}6800_SYNCH_MASS.
   Incoming data structures are mapped to API_{—}6800 structures
   Web-service interfaced to function module

The exemplary embodiments described above relate to the process steps, interfaces and access to Trade software, application or system(s), which invoke or call different business objects for updates and services checks. This Trade system solution may be implemented as a standalone application delivering automated services that allow enterprises to comply with various trade regulations. The exemplary embodiments provide key critical steps and access to provide an interface for submitting information to existing Trade System modules, for registering different data elements and further processing for trade service checks against the configured business rule and settings in one or more systems. If the data mapping is met, the service will create a corresponding equivalent record or document, for example either in electronic form such as a PDF or other standard electronic document or as a printed form of a document, referencing the original Trade document or system or stores Trade information and flags it for review. This exemplary embodiment may optionally access and perform Trade related functions within the Trade Application using this interface call.

What is claimed is:

1. An automated method of generating trade system transaction documentation, the method comprising:
registering a product, triggering an automatic selection of a product classification or product content attributes from a transactional system;
registering a business partner, triggering an automatic selection of business partner attributes from the transactional system;
comparing automatically the product classification or product content attributes with the trade regulations and setting a transaction flag to allow or deny a transaction;
comparing automatically the business partner attributes with the restricts, denial list and setting a transaction flag to allow or deny a transaction;
halting further processing of the transaction if the transaction flag is set to deny a transaction and automatically forwarding transaction information to a transaction review process and;
allowing the transaction process to proceed if the transaction flag is set to allow a transaction, and automatically creating a business transaction and generating transaction specific documents.

2. A method as recited in claim 1, further comprising generating a license request when the transaction flag is set to deny a transaction in the transaction process is forwarded to a transaction review process.

3. A method as recited in claim 1, for simulating the Trade regulation, agreement or risk assessment based on the product attributes, business partner and transactional attributes

4. A method as recited in claim 1, for compliance check on a product, business partner and inbound and outbound processing with service calls from an external interface

5. A method as recited in claim 1, further comprising generating either a purchase order, a sales order, a contract, a delivery note, a service order, or another business transaction specific document when the transaction flag is set to allow a transaction and the transaction process is allowed to proceed.

6. A method as recited in claim 1, further comprising generating either customs documentation, duty documentation, or restriction documentation when the transaction flag is set to allow a transaction and the transaction process is allowed to proceed.

7. A method as recited in claim 1, further comprising the step of triggering an import or export control attribute associated with the product after triggering an automatic selection of a product classification or product content attributes from a transactional system

8. A method as recited in claim 1, further comprising the step of triggering an automatic selection of a denied party list for each business partner after triggering an automatic selection of business partner attributes from the transactional system.

9. A method as recited in claim 1, further comprising generating United States Customs Service approved forms when the transaction process is allowed to proceed.

10. A method as recited in claim 8, further comprising printing United States Customs Service approved forms.

11. A method as recited in claim 8, further comprising generating electronic or computer compatible forms that are acceptable by the United States Customs Service.

12. A method as recited in claim 8, whereby the method is implemented by instructions stored on a machine readable medium.

13. A trade system computer program product, comprising:
a computer usable medium having computer usable program code embodied therewith, the computer usable program code comprising:
computer usable program code configured to register a product, triggering an automatic selection of a product classification or product content attributes from a transactional system;
computer usable program code configured to register a business partner, triggering an automatic selection of business partner attributes from the transactional system
computer usable program code configured to automatically compare the product classification or product content attributes with the business partner attributes, setting a transaction flag to allow or deny a transaction;
computer usable program code configured to halt further processing of the transaction if the transaction flag is set to deny a transaction and automatically forward transaction information to a transaction review process and;
computer usable program code configured to allow the transaction process to proceed if the transaction flag is set to allow a transaction, and automatically create a business transaction and generating transaction specific documents.

14. A trade system computer program product as recited in claim 13, further comprising a computer usable program code configured to generate a license request when the transaction flag is set to deny a transaction in the transaction process is forwarded to a transaction review process.

15. A trade system computer program product as recited in claim 13, further comprising a computer usable program code configured to simulate a Trade regulation process, agreement or risk assessment based on the product attributes, business partner and transactional attributes.

16. A trade system computer program product as recited in claim 13, further comprising a computer usable program code configured to implement a compliance check on product, business partner and inbound and outbound processing with service calls from an external interface.

17. A trade system computer program product as recited in claim 13, further comprising a computer usable program code configured to generate either a purchase order, a sales order, a contract, a delivery note, a service order, or another business transaction specific document when the transaction flag is set to allow a transaction and the transaction process is allowed to proceed.

18. A trade system computer program product as recited in claim 13, further comprising a computer usable program code configured to generate either customs documentation, duty documentation, or restriction documentation when the transaction flag is set to allow a transaction and the transaction process is allowed to proceed.

19. A trade system computer program product as recited in claim 13, further comprising a computer usable program code configured to trigger an import or export control attribute associated with the product after triggering an automatic selection of a product classification or product content attributes from a transactional system

20. A trade system computer program product as recited in claim 13, further comprising a computer usable program code configured to trigger an automatic selection of a denied party list for each business partner after triggering an automatic selection of business partner attributes from the transactional system.

21. A trade system computer program product as recited in claim 13, further comprising a computer usable program code configured to generate United States Customs Service approved forms when the transaction process is allowed to proceed.

22. A trade system computer program product as recited in claim 20, further comprising a computer usable program code configured to print United States Customs Service approved forms.

23. A trade system computer program product as recited in claim 13, further comprising a computer usable program code configured to generate electronic or computer compatible forms that are acceptable by the United States Customs Service.
